(19) United States
(12) Patent Application Publication
(10) Pub. No.: US 2026/0008962 A1
(43) Pub. Date: Jan. 8, 2026

(54) HYDROPROCESSING OF WASTE TYRE PYROLYSIS OIL WITH VEGETABLE AND/OR FATTY MATERIAL

(71) Applicant: TOPSOE A/S, Kgs. Lyngby (DK)

(72) Inventors: Christian Ejersbo STREBEL, Kgs. Lyngby (DK); Jostein GABRIELSEN, Kgs. Lyngby (DK); Magnus Zingler STUMMANN, Kgs. Lyngby (DK)

(73) Assignee: TOPSOE A/S, Kgs. Lyngby (DK)

(21) Appl. No.: 18/997,245

(22) PCT Filed: Jun. 29, 2023
(86) PCT No.: PCT/EP2023/067794

§ 371 Date: Jan. 21, 2025

(30) Foreign Application Priority Data
Jul. 22, 2022 (DK) PA202200709

(51) Int. Cl. C10G 3/00

(52) U.S. Cl. CPC C10G 3/50; C10G 2300/1007; C10G 2300/4006; C10G 2300/4012; C10G 2300/4018; C10G 2400/04; C10G 2400/08

(57) ABSTRACT

Process and plant for producing a hydrocarbon feed comprising: providing a bio-crude oil feed comprising 0.1-5 wt % oxygen (O); providing a vegetable oil and/or fatty material feed; combining the bio-crude oil comprising 0.1-5 wt % O with the vegetable oil and/or fatty material feed, for producing said hydrocarbon feed; wherein said bio-crude oil feed comprising 0.1-5 wt % O is a waste tyre pyrolysis oil feed.

The present invention relates to a process and plant for hydroprocessing of a bio-crude oil feed produced from the thermal decomposition of a solid feed stream, together with a vegetable and/or fatty material feed. The solid feed stream comprises waste tyres, the thermal decomposition is pyrolysis, and the bio-crude oil feed is waste tyre pyrolysis oil.

The co-processing hydrocarbon fuel feeds by combining a fossil fuel feed such as petroleum feed with a vegetable oil feed in hydroprocessing, is well-known. However, bio-crude oils produced by thermal decomposition such as by pyrolysis and hydrothermal liquefaction (HTL) of a solid renewable feed, e.g. lignocellulosic biomass, are generally not miscible with vegetable oils and/or fatty materials including fatty acids, thus co-processing of these feeds in a hydroprocessing step such as hydrodeoxygenation (HDO) has so far been a significant challenge to overcome.

Stummann et al. “Hydrotreatment of Catalytic Fast Pyrolysis Oil to Renewable Fuels”, NAM27, The 27^{th} North American Catalysis Society Meeting, May 22-27, 2022 New York, NY, discloses a study where a Catalytic Fast Pyrolysis (CFP) oil is combined with a vegetable oil, here soy oil, in a stirred batch reactor.

Still, Applicant finds that vegetable oil is not miscible with most untreated catalytic pyrolysis oils, hence it is highly difficult to make it work in an industrial hydrotreating reactor. The hydrotreating reactor processing the co-feed will plug after few days when running at industrially relevant conditions.

It has now been found that despite that vegetable oil is not miscible in catalytic and non-catalytic pyrolysis and hydrothermal liquefaction (HTL) bio-crude oil, it is miscible in waste tyre pyrolysis oil. The latter has a low content of oxygen (O) and thus may be regarded as being partly deoxygenated.

Accordingly, in a general embodiment according to a first aspect of the invention, there is provided a process for producing a hydrocarbon feed, comprising the steps of:
providing a bio-crude oil feed comprising 0.1-5 wt % oxygen (O);
providing a vegetable oil and/or fatty material feed;
combining the bio-crude oil feed comprising 0.1-5 wt % O with the vegetable oil and/or fatty material feed, for producing said hydrocarbon feed;

wherein said bio-crude oil feed comprising 0.1-5 wt % O is a waste tyre pyrolysis oil feed.

For instance, separate waste tyre pyrolysis oil feeds may be combined into a single waste tyre pyrolysis oil feed comprising 0.1-5 wt % O.

For instance, the waste tyre pyrolysis oil feed(s) may be combined with a vegetable oil feed or a fatty material feed such as an animal fat feed.

For instance, the waste tyre pyrolysis oil feed(s) may be combined first with a vegetable oil feed and then with a fatty material feed such as an animal fat feed.

Optionally, an additional feed may be provided.

It would be understood that the term “waste tyre pyrolysis oil feed” means the liquid oil produced from waste tyre pyrolysis.

The bio-crude oil feed comprising 0.1-5 wt % oxygen (O) may be regarded as a partly deoxygenated bio-crude oil feed.

Hence, it is now possible to combine the waste pyrolysis oil with vegetable oil and/or fatty material feed without the risk of plugging a downstream hydroprocessing reactor such as hydrotreating in a hydrodeoxygenation and/or deoxygenation (HDO/DO) reactor, or any associated units such as pumps and heat exchangers. Further, the vegetable oil serves to cool the effluent from the HDO/DO reactor i.e. the partly deoxygenated bio-crude oil feed, or as cooling between the catalytic beds in the first HDO reactor. Furthermore, the formation of a heavy end fraction in a downstream separation section is reduced, thereby increasing the production of e.g. diesel as hydrocarbon fuel. While an oxygen (O) content below 2 wt % in the bio-crude oil feed may contribute to render it miscible with the vegetable oil and/or fatty material, such low values of oxygen in bio-crude oil feeds of oxygen tend to be accompanied by low aromatic content. In contrast herewith, it has been found, that waste pyrolysis oil, having a content of oxygen as low as 0.1-5 wt %, such as 0.5-2 wt %, not only is miscible with the vegetable oil and/or fatty material feed, but maintains a high level of aromatic compounds. As it will also be explained further below, the presence of a significant number of aromatic compounds is desirable as this enables reducing the heavy end formation when producing and/or separating downstream a hydrocarbon product such as diesel.

In an embodiment, prior to said combining step, the process further comprises:
prior to said combining step, supplying the waste tyre pyrolysis oil feed to a stabilization step in a stabilization reactor, for producing a stabilized waste tyre pyrolysis oil feed.

The stabilization reactor is herein also referred to as selective hydrogenation unit. Since the waste tyre pyrolysis oil has a high concentration of aromatics, a decrease in the heavy end formation in a downstream section for producing hydrocarbon fuels, is obtainable; suitably by hydroprocessing, e.g. hydrotreating (HDO/DO), the stabilized tyre pyrolysis oil and which is then combined with the vegetable oil and/or fatty material.

In an embodiment, the stabilization step is conducted in continuous operation mode in a fixed bed reactor comprising supplying the bio-crude oil feed with hydrogen in the presence of any of a: Ni—Mo, Co—Mo, Ni—Cu, Mo, Pt, Pd, Ru, or Ni based catalyst, at a temperature of 20-240° C., a pressure of 50-150 barg, optionally a liquid hourly space velocity (LHSV) of 0.1-2 h⁻¹, and a hydrogen to liquid oil ratio, defined as the volume ratio of hydrogen to the flow of the liquid oil stream (waste tyre pyrolysis oil feed), of 250-3000 NL/L, such as 500-2500 NL/L, thereby forming said stabilized waste tyre pyrolysis oil feed.

For instance, the catalyst is a Ni-Mo based catalyst, or a Co—Mo based catalyst, or a Ru/TiO₂ based catalyst (Ruthenium supported on titania), or Pt/TiO₂ based catalyst.

The term “Ni—Mo based catalyst”, “Co—Mo based catalyst”, or the like, means that Ni—Mo are the active elements of the catalyst.

Suitably, Ni—Mo, Co—Mo, or Mo are in sulfided form e.g. NiMoS. Suitably also, Ni is in sulfided or reduced form.

By the term “stabilization” is meant converting carbonyl groups present in compounds of the liquid oil, such as aldehydes, ketones and acids, into alcohols. Other molecules such as sugars and furans may also be converted in the stabilization step. Further, diolefins such as conjugated diolefins are hydrotreated. For instance, this stabilization step can be conducted by means of NiMo based catalysts, as disclosed in Shumeico et al. “Efficient one-stage bio-oil upgrading over sulfide catalysts”, ACS Sustainable Chem. Eng. 2020, 8, 15149-15167. Suitably, the stabilization is conducted according to the method disclosed in Applicant's co-pending European patent application 21152117.4 (corresponding to international application PCT/EP2022/050877).

In an embodiment, the vegetable oil and/or fatty material feed is a non-hydroprocessed vegetable oil and/or fatty material feed. Thus, this feed has not been subjected to a prior hydroprocessing step such as hydrodeoxygenation (HDO).

For the purposes of the present application, the term “first aspect of the invention” relates to the process. The term “second aspect of the invention” refers to the process plant, i.e. plant.

The term “present invention” and “present application” are used interchangeably.

The term “comprising” includes “comprising only”, i.e. “consisting of”.

The term “suitably” is used interchangeably with the term “optionally”, i.e. an optional embodiment.

The term “bio-crude oil feed comprising 0.1-5 wt % oxygen (O)” may be used interchangeably with the term “partly deoxygenated bio-crude oil feed”.

The term “bio-crude oil feed” means the waste tyre pyrolysis oil product of a thermal decomposition step in a thermal decomposition unit, in which the thermal decomposition unit is a pyrolysis unit. The term “unit” is understood here as “reactor”.

The bio-crude oil feed, here specifically waste tyre pyrolysis oil, may also be understood as an “advanced bio-crude”.

The term “vegetable oil feed and/or fatty materials” includes vegetables oils such as soy oil, and fatty materials such as animal fat. The fatty materials include fatty acids. The term “section”, for instance “hydroprocessing section”, means a physical section comprising a unit or combination of units for conducting one or more steps and/or sub-steps for e.g. producing a hydroprocessed hydrocarbon feed or a further hydroprocessed hydrocarbon feed.

The term “hydroprocessing” encompasses hydrotreating, thus hydrodeoxygenation or deoxygenation (HDO/DO). The term “hydroprocessing” encompasses also hydroisomerisation” (HDI), or hydrocracking (HCR), or hydrodearomatisation (HDA). It would be understood that a hydroprocessing step, such as a HDO/DO step is conducted in a hydroprocessing reactor such as HDO/DO reactor, or in a catalytic bed of the hydroprocessing reactor such as in a catalytic bed of the HDO/DO reactor. A hydroprocessing reactor may comprise one or more catalytic beds.

Other definitions are recited below in connection with one or more embodiments of the invention.

Suitably, said combining step is with a weight ratio (A:B) of the bio-crude oil feed i.e. waste tyre pyrolysis oil feed (A) to vegetable oil and/or a fatty material feed (B) in the range: 9:1 i.e. wt % ratio of 90:10, to 1:9 i.e. wt % ratio of 10:90, such as 3:1 i.e. wt % ratio of 75:25, 2:1 i.e. wt % ratio of 66.6:33.3, 1:1 i.e. wt % ratio of 50:50, 1:2 i.e. wt % 33.3:66.6, 1:3 i.e. wt % 25:75, 1:4 i.e. wt % 20:80, 1:5 i.e. wt % 17:83, 1:6 e.g. 1:5.7 i.e. wt % 15:85.

It would be understood that the above weight ratios are also applicable when combining hydroprocessed feeds, for instance when combining a hydrotreated waste tyre pyrolysis oil feed with a hydrotreated vegetable oil feed.

In an embodiment, the process further comprises a pyrolysis step in a pyrolysis unit which comprises feeding to the pyrolysis unit: a solid feed stream comprising at least 50 wt % waste tyre-particles for producing said waste tyre pyrolysis oil feed.

In an embodiment, the solid feed stream comprises at least 60 wt %, or at least 70 wt % or at least 80 wt % or at least 90 wt % waste tyre particles, and the waste tyre pyrolysis oil feed comprises 0.5-2 wt % O.

The higher the content of waste tyre particles in the solid feed stream, the lower the oxygen content obtainable in the waste pyrolysis oil feed. For instance, solid feed stream to the pyrolysis unit comprising at least 90 wt % waste tyre particles, produces a waste tyre pyrolysis oil feed comprising 1 wt % O or less, thereby also enabling milder conditions in the stabilization step, e.g. by using temperatures in the lower range, or in a subsequent hydroprocessing step.

The pyrolysis step is, in an embodiment, a fast pyrolysis step.

The pyrolysis step may include the use of a pyrolysis unit such as fluidized bed, transported bed, or circulating fluid bed, as is well known in the art. For instance, the pyrolysis step may comprise the use of a pyrolysis unit (also referred herein as pyrolysis reactor), cyclone(s) to remove particulate solids such as char, and a cooling unit for thereby producing said first off-gas stream (i.e. pyrolysis off-gas) and said first liquid oil stream, i.e. condensed pyrolysis oil. This first off-gas stream comprises light hydrocarbons e.g. C1-C4 hydrocarbons, CO and CO₂. The first liquid oil stream is also referred to as pyrolysis oil or bio-oil and is a liquid substance rich in blends of molecules usually consisting of more than two hundred different compounds including aldehydes, ketones and/or other compounds such as furfural having a carbonyl group, resulting from the depolymerisation of products treated in pyrolysis.

For the purposes of the present invention, the pyrolysis step is preferably fast pyrolysis, also referred in the art as flash pyrolysis. Fast pyrolysis means the thermal decomposition of a solid renewable feedstock in the absence of oxygen, at temperatures in the range 350-650° C. e.g. about 500° C. and reaction times of 10 seconds or less, e.g. below 10 seconds, such as 5 seconds or less, e.g. about 2 seconds; i.e. the vapor residence time is 10 seconds or below, such as 2 seconds or less e.g. about 2 seconds.

Traditionally, fast pyrolysis may for instance also be conducted by autothermal operation e.g. in a fluidized bed reactor. The latter is also referred as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g. “Heterodoxy in Fast Pyrolysis of Biomass” by Robert Brown: https://dx.doi.org/10.1021/acs.energyfuels.0c03512

Thus, in an embodiment of the present application, the use of autothermal pyrolysis. i.e. autothermal operation, as a particular embodiment for conducting fast pyrolysis, is provided, i.e. the pyrolysis step is conducted by autothermal pyrolysis.

There are several types of fast pyrolysis where a catalyst is used. Sometimes an acid catalyst, such as a zeolite catalyst, is used in the pyrolysis unit (pyrolysis reactor) to upgrade the pyrolysis vapors; this technology is called catalytic fast pyrolysis (CFP) and can both be operated in an in-situ mode (the catalyst is located inside the pyrolysis unit), and an ex-situ mode (the catalyst is placed in a separate reactor; i.e. the pyrolysis gas is sent to a deoxygenation (DO) reactor for catalytically deoxygenating it prior to condensation of a pyrolysis oil, as described farther above). More specifically, in in-situ catalytic fast pyrolysis the catalyst is located inside the pyrolysis unit and the deoxygenation (through e.g. decarbonylation, decarboxylation by an acid-based catalyst such as a zeolite catalyst) takes place inside the pyrolysis reactor immediately after the pyrolysis vapours are formed. Suitable catalysts for CFP include alumina and all the types of zeolite catalysts that are normally used for hydrocracking (HCR) and cracking in refinery processes, such as HZSM-5. A more extensive list of catalytic material for HCR is provided farther below in the present application.

Similarly, in in-situ HDO (also called reactive catalytic fast pyrolysis, RCFP), a hydrotreating (HDO) catalyst is located in the pyrolysis unit, and the pyrolysis vapors are thereby hydrodeoxygenated immediately in the pyrolysis reactor after they are formed. Suitably catalysts for HDO are metal-based catalysts, including reduced Ni, Mo, Co, Pt, Pd, Re, Ru, Fe, such as CoMo or NiMo catalysits, suitably also in sulfide form: CoMOS, NiS, NiMOS, NiWS, RuS. The catalyst supports may be the same in conventional HDO in refinery processes, typically a refractory support such as alumina, silica or titania, or combinations thereof. Farther below in the present application, HDO conditions are also recited.

In ex-situ deoxygenation (DO), the vapors are deoxygenated in a separate DO reactor located after the pyrolysis unit. Thus, in ex-situ catalytic fast pyrolysis, the vapors are deoxygenated using an acid catalyst, such as a zeolite catalyst.

In ex-situ HDO, the pyrolysis vapors are hydrodeoxygenated in a separate HDO reactor located after the pyrolysis reactor using a hydrotreating catalyst.

The use of a catalyst in the pyrolysis reactor conveys the advantage of lowering the activation energy for reactions thereby significantly reducing the required temperature for conducting the pyrolysis. In addition, increased selectivity towards desired pyrolysis oil compounds may be achieved.

It would be understood that where hydrogen is added to the catalytic fast pyrolysis, it is called reactive catalytic fast pyrolysis (RCFP). Further, if the catalytic fast pyrolysis is conducted at a high hydrogen pressure (˜>5 barg) it is often called catalytic hydropyrolysis (CHP). Hydropyrolysis (HP) means that hydrogen is added to the pyrolysis, yet at atmospheric pressure.

The pyrolysis step is suitably also a simple fast pyrolysis, which for the purposes of this application means fast pyrolysis being conducted without the presence of a catalyst and hydrogen in the pyrolysis unit, i.e. the fast pyrolysis is not any of: catalytic fast pyrolysis (CFP), hydropyrolysis (HP), reactive catalytic fast pyrolysis (RCFP) or catalytic fast hydropyrolysis (CHP). The pyrolysis unit may not include a HDO reactor downstream. This enables a much simpler and inexpensive process.

The table below summarizes the different options for fast pyrolysis apart from autothermal pyrolysis:

| | Hydrogen | Catalyst | HDO within | DO within |
|---|---|---|---|---|
| Fast | added to | within | or outside | or outside |
| pyrolysis | pyrolysis | pyrolysis | pyrolysis | pyrolysis |
| type | unit | unit | unit | unit |
| Simple fast | no | no | outside | no |
| pyrolysis | | | (ex-situ | |
| | | | HDO) | |
| Simple fast | no | no | No | no |
| pyrolysis | | | | |
| in-situ CFP | no | yes (acid | No | Inside |
| | | catalyst) | | |
| ex-situ CFP | no | no | No | outside |
| | | | | (ex-situ DO) |
| RCFP | yes | yes (HDO | Inside | no |
| (in-situ | | catalyst) | | |
| HDO) | | | | |
| HP | yes | yes/no | Outside | outside |
| CHP | yes, at high | As for | As for | As for |
| | H₂ pressure | RCFP, HP | RCFP, HP | RCFP, HP |
| | (>5 barg) | | | |

Accordingly, in an embodiment the pyrolysis step is fast pyrolysis, in which the vapor residence time is 10 seconds or less, e.g. below 10 seconds, such as 5 seconds or less, e.g. about 2 seconds, or 1 second, or in the range 1-5 seconds, and which is selected from: simple fast pyrolysis; in-situ catalytic fast pyrolysis (in-situ CFP); ex-situ catalytic fast pyrolysis (ex-situ CFP); reactive catalytic fast pyrolysis (RCFP); hydropyrolysis (HP); catalytic fast hydropyrolysis (CHP).

In another embodiment, the pyrolysis step is intermediate pyrolysis, in which the vapor residence time is in the range of 10 seconds-5 minutes, such as 11 seconds-3 minutes. As for fast pyrolysis, the temperature is also in the range 350-650° C. e.g. about 500° C. Often this pyrolysis is conducted in pyrolysis reactors handling different types of waste, where the vapor is burned after the pyrolysis reactor. Typical reactors are: Herreshoff furnace, rotary drums, amaron, CHOREN paddle pyrolysis kiln, auger reactor, and vacuum pyrolysis reactor.

In another embodiment, the pyrolysis step is slow pyrolysis, in which the solid residence time is in the range of 5 minutes-2 hours, such as 10 min-1 hour. The temperature is suitably about 300° C. This pyrolysis gives a high char yield and the char can be used as a fertilizer or as char coal; the pyrolysis still produces some gas and biocrude and if the carbon is used a fertilizer the final bio-oil can have a GHG above 100%, thus being carbon negative. Typical reactors are auger reactor—yet with a different residence time than for intermerdiate pyrolysis-, fixed bed reactor, kiln, lambiotte SI-FIC/CISR retort, Lurgi process, wagon reactor, and carbo twin resort.

In an embodiment, the pyrolysis step further comprises a preliminary step of passing said solid renewable feedstock through a solid renewable feedstock preparation section comprising for instance drying for removing water and/or comminution for reduction of particle size. Any water/moisture in the solid renewable feedstock which vaporizes in for instance the pyrolysis section condenses in the pyrolysis oil stream and is thereby carried out in the process, which may be undesirable. Furthermore, the heat used for the vaporization of water withdraws heat which otherwise is necessary for the pyrolysis. By removing water and also providing a smaller particle size in the solid renewable feedstock the thermal efficiency of the pyrolysis step is increased.

The preliminary step may also comprise conducting an acid wash for removing metals. This is particularly relevant for pyrolysis processes where the catalyst is located in the pyrolysis reactor. The removal of metals from the solid renewable feedstock increases the catalyst lifetime.

In particular, it has been found that the hydrocarbon fuel diesel produced from a waste tyre pyrolysis oil feed comprising 0.1-5 wt %. such as 0.5-2 wt % O, is rich in aromatics and the density and cetane index of the diesel fraction is therefore too high to fulfill EN590 diesel specifications. Hence, a significant problem associated with such advanced bio-crude oil (i.e. the waste tyre pyrolysis oil) is that it has so many aromatics that it is not necessarily enough to perform a hydrodearomatization (HDA) step in a HDA reactor, because cycle alkanes also do not have the best cetane index, thus ring-opening by hydrocracking would be necessary. However, by co-processing it with e.g. vegetable oil it is now possible to minimize the hydrocracking and/or isomerization needed to get a good cetane index, such as a cetane index (CCI according to standard ASTM D4737), hereinafter also simply referred to as CCI, higher than 40, for instance 45-60, while at the same time increasing the diesel yield.

For instance, hydrotreated vegetable oil (HVO), or hydrotreated cooked oil (hydrotreated used cooking oil), has very high cetane index (CCI) and low density but the cold flow properties are poor. The cold flow properties are suitably measured by the cloud point (CP according to ASTM D57773), hereinafter also simply referred to as CP. The combination of the waste tyre pyrolysis oil feed from the pyrolsyis of waste tyres, with HVO or hydrotreated cooked oil, optionally with subsequent hydroisomerization (HDI), results in a particularly good diesel fuel in compliance with EN590 specs; including compliance with the desirable cold flow properties, e.g. in terms of cloud point (CP).

A significant synergistic effect at least in terms of reduction of CP and/or reduction of heavy end formation, is thereby achieved.

For instance, the CP of a hydrotreated waste pyrolysis oil (H-WTP oil) is 6° C., while the CP of HVO is 22° C. By combining the H-WTP oil with the HVO, the CP surprisingly can be reduced to a value which is significantly lower than that of either H-WTP or HVO, such as −4° C.

Accordingly, in an embodiment said vegetable oil and/or fatty material feed is a hydro-processed, e.g. hydrotreated, vegetable oil and/or fatty material feed (e.g. hydrotreated vegetable oil feed and/or hydrotreated fatty material feed). Suitably, this feed is externally sourced.

In an embodiment, the process further comprises supplying the vegetable oil and/or fatty material feed, prior to combining with the waste tyre pyrolysis oil feed, to a hydro-deoxygenation or deoxygenation (HDO/DO) step in a HDO/DO reactor, for producing a hydroprocessed, e.g. hydrotreated, vegetable oil and/or fatty material feed. Thereby, the e.g. hydrotreated vegetable oil, such as HVO or hydrotreated cooked oil, is internally sourced and integrated in the process.

In an embodiment, the process further comprises supplying the waste tyre pyrolysis oil feed or the stabilized waste tyre pyrolysis oil feed, prior to combining with the vegetable oil and/or fatty material or with the hydroprocessed vegetable oil and/or fatty material feed, to a hydrodeoxygenation or deoxygenation (HDO/DO) step in a HDO/DO reactor, for producing a hydroprocessed waste tyre pyrolysis oil feed or a hydroprocessed stabilized waste tyre pyrolysis oil feed.

Since the waste tyre pyrolysis oil, despite the low content of oxygen, is rich in aromatics, there is a decrease in the heavy end formation by hydroprocessing, e.g. hydrotreating, the waste tyre pyrolysis oil feed or the stabilized waste tyre pyrolysis oil feed, with the vegetable oil and/or fatty material.

In an embodiment, the waste tyre pyrolysis oil feed may contain a significant amount of aromatics. Hence, the waste tyre pyrolysis oil feed may contain 35-65 wt % aromatics (total), e.g. 45-55 wt % aromatics (total), as measured according to ASTM D6591.

The hydroprocessed stabilized waste tyre pyrolysis oil feed may contain 25-55 wt % aromatics (total), e.g. 35-50 wt % aromatics (total), as measured according to ASTM D6591.

In a particular embodiment, said HDO/DO step of the waste pyrolysis oil feed or the stabilized waste tyre pyrolysis oil feed, is conducted in the same HDO/DO reactor for conducting HDO/DO step of the vegetable oil and/or fatty material feed.

Thereby, simplicity by integration in the process and plant is obtained, with attendant reduction in plot size and consequently capital and operating expenses. For instance, in the same HDO/DO reactor, a vegetable oil is hydrotreated in a first catalytic bed and then combined with waste tyre pyrolysis oil feed or stabilized waste tyre pyrolysis oil feed prior to entering a second catalytic bed downstream in the HDO/DO reactor.

It would by understood that although strictly speaking deoxygenation (DO) is without the presence, e.g. by addition, of hydrogen, for the purposes of the present application it is still regarded as a hydroprocessing step.

The hydrocarbon feed, which combines A) the waste tyre pyrolysis oil feed with B) the vegetable oil and/or fatty material, may thus be produced from:
A) waste tyre pyrolysis oil feed, or stabilized waste tyre pyrolysis oil feed, or hydroprocessed waste tyre pyrolysis oil feed, or hydroprocessed stabilized waste tyre pyrolysis oil feed; and
B) vegetable oil and/or fatty material, or hydroprocessed vegetable oil and/or fatty material.

An additional feed may further be combined, as recited farther below.

Hence, the waste tyre pyrolysis oil may or may not be hydroprocessed, e.g hydrotreated; and the vegetable oil and/or fatty material may or may not be hydroprocessed, e.g. hydrotreated, prior to being combined into said hydrocarbon feed.

In an embodiment, the process further comprises supplying said hydrocarbon feed to a subsequent HDO/DO step, optionally in a subsequent HDO/DO reactor, for producing a hydroprocessed hydrocarbon feed.

Thereby, several layouts are proposed; for instance:
the provision of at least two HDO/DO reactors, where e.g. vegetable oil is hydrotreated for producing a hydrotreated vegetable oil, which is then mixed with the with waste tyre pyrolysis oil feed or stabilized waste tyre pyrolysis oil feed, and the mixture i.e. the hydrocarbon feed is sent to a subsequent (second) HDO/DO reactor.
the provision of only one HDO/DO reactor and co-process vegetable oil or hydrotreated vegetable oil in a first catalytic bed, which is then mixed with the with waste tyre pyrolysis oil feed or stabilized waste tyre pyrolysis oil feed, and the mixture is feeding it to the lower (downstream) catalytic beds in the HDO/DO reactor.

The present application makes it possible to co-process vegetable oils and/or fatty materials such as fatty acids, with waste tyre pyrolysis oil, which is otherwise not possible. Further, the e.g. vegetable oil is used to cool the product from the HDO/DO reactor or as cooling between the beds in the HDO reactor.

In an embodiment, the process further comprises:
supplying said hydrocarbon feed or said hydroprocessed hydrocarbon feed to a subsequent hydroprocessing step in a downstream hydroprocessing section, such as a hydroisomerisation (HDI) step in a HDI reactor, and/or a hydrocracking (HCR) step in a HCR reactor, and/or a hydrodearomatization (HDA) step in a HDA reactor, for producing a further hydroprocessed hydrocarbon feed.

The subsequent hydroprocessing step thus comprises treating the combined feed in one or more additional catalytic hydrotreating units under the addition of hydrogen, such as third catalytic hydrotreating unit or a cracking section. For instance, it would be understood that when a hydrocarbon product boiling in the jet fuel range is desired, a hydrocracking (HCR) unit is suitably used, for instance prior to passing the thus hydrotreated stream to HDI.

It would be understood that this embodiment encompasses a process in which the hydrocarbon feed does not comprise waste tyre pyrolysis feed which has been subjected to a HDO/DO step and/or vegetable oil and/or fatty material feed which has been subjected to a HDO/DO step.

Normally the pyrolysis oil contains a high amount of oxygen compound and unsaturated hydrocarbon. During the hydrotreating of this feed, the oxygen is mainly removed as H₂O, which gives a fuel consisting of mainly naphthenes and aromatics. This is called the hydrodeoxygenation (HDO) pathway. Oxygen can also be removed by the decarboxylation pathway, which generates CO₂ instead of H₂O:
HDO pathway: RCH₂COOH+3 H₂⇄RCH₂CH₃+2 H₂O
Decarboxylation pathway: RCH₂COOH⇄RCH₃+CO₂

Further, while decarbonylation normally does not dominate in HDO of triglycerides in typical renewable feeds, it can more dominant during HDO of pyrolysis oil: Decarbonylation pathway: RCH₂COH+H₂<->RCH₃+CO

The material catalytically active in HDO (as used herein, interchangeable with the term hydrotreating), typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

HDO conditions involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product.

The material catalytically active in hydroisomerization HDI typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof).

HDI conditions involve a temperature in the interval 250-400° C., a pressure in the interval 20-100 bar, and a liquid hourly space velocity (LHSV) in the interval 0.5-8.

The material catalytically active in hydrocracking (HCR) is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica:alumina ratio.

HCR conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product.

The material catalytically active in HDA typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

HDA conditions involve a temperature in the interval 200-350° C., a pressure in the interval 20-100 bar or 20-200 bar, and a liquid hourly space velocity (LHSV) in the interval 0.5-8.

In an embodiment, the process comprises:
supplying the further hydroprocessed hydrocarbon feed to a separation step in a separation section for producing a hydrocarbon product, said hydrocarbon product being any one of: naphtha, diesel, jet fuel, maritime (marine) fuel as a heavy end, or combinations thereof.

The maritime (marine) fuel is thus suitably withdrawn as the heavy end fraction.

In an embodiment, the weight ratio (A:B) of waste tyre pyrolysis oil feed (A) to vegetable oil and/or a fatty material feed (B) is in the range 50:50 wt % to of 90:10 wt %, such as 60:40, 70:30, 75:25, 80:20, or 85:15 wt %; and optionally any of the HDO/DO steps is conducted in continuous mode under the conditions: 250-400° C., such as 350-380° C., at a pressure of 50-150 bar, such as 100 bar, and with a fixed bed catalyst in which the catalyst is NiMoS. and/or MoS.

At the above weight ratios (A:B), for instance by combining a hydroprocessed, e.g. hydrotreated waste tyre pyrolysis oil and a hydrotreated vegetable oil, e.g. HVO, the resulting diesel shows desirable results in terms of cetane index and compliance with specifications (EN590 specs), including also improved cold flow properties in terms of cloud point. High synergy is at least achieved by the cloud point of the resulting diesel being lower than either A or B. In addition, providing MoS catalyst, for instance by loading it on the top of the HDO/DO reactor, further reduces the heavy end formation.

It would be understood that the temperature of a given reactor refers to the inlet temperature in an adiabatic fixed bed reactor, or the reaction temperature in an isothermal reactor.

Suitably, the stabilization reactor and any of the hydroprocessing reactors such as a HDO/DO reactor or HDI or HCR reactor or HDA reactor, is an adiabatic fixed bed reactor.

The particular combination of co-processing in these weight ratios and the provision of a NiMOS and/or MOS catalyst in the subsequent HDO/DO step, as recited above, enables further reducing the heavy end fraction (C18+ formation). The yield of diesel, this being the C15-C18 range, is thus increased.

The desirable hydrocarbon product downstream is, in an embodiment, diesel as a hydrocarbon product boiling in the transportation fuel range, which is suitably represented by C15-C18 hydrocarbons. Hydrocarbons with carbon numbers above 18 (C18+) may be withdrawn downstream in the separation section as a heavy end fraction (herein also referred to as heavy end), yet it would be desirable to reduce this heavy end fraction for thereby increasing the yield of the C15-C18 fraction and thus the diesel fuel. It has been found that the invention enables a lower production of the heavy end fraction, while still maintaining proper miscibility of the feeds. Without being bound by any theory, it is believed that the aromatics in the waste tyre pyrolysis oil feed act as a hydrogen donor, despite the low O content as already mentioned, and thereby decrease the heavy end formation. The conventional approach when dealing with heavy ends is to conduct hydrocracking of the heavy part of the product and thereby remove the heavy end. However, hydrocracking leads to a yield loss, thus minimizing the heavy end formation increases the overall yield of the process, in particular the diesel yield. In addition, as explained, the cold flow properties in terms of cloud point are significantly improved.

In an embodiment, said vegetable oil and/or fatty material feed is any of: soy oil such as soy bean oil, rapeseed oil, corn oil, castor oil, cooked oil, animal fat such as beef, pork, milk, and chicken fat;
and combinations thereof.

For instance, said fatty material feed comprises fatty acids; the fatty material feed suitably being any of: triglycerides, diglycerides, monoglycerides, and free fatty acids.

As recited farther above, in an embodiment, the hydroprocessed vegetable oil and/or fatty material is selected from hydrotreated vegetable oil (HVO) or hydrotreated cooked oil.

This particular co-feed results in a diesel fuel in compliance with EN590 specs including improved cold flow properties, with a high cetane index of produced diesel, for instance in the range 40-60, low amount of heavy end fraction. In addition, the cloud point may be significantly reduced, by providing a cloud point which is much lower than either the waste tyre pyrolysis oil alone or e.g. a vegetable oil alone, as already explained above.

When combining the bio-crude oil comprising 0.1-5 wt % O, i.e. the waste tyre pyrolysis oil, with the vegetable oil and/or fatty material feed, for producing said hydrocarbon feed, additional feeds may be provided. Accordingly, in an embodiment, the step of combining the waste tyre pyrolysis oil feed with the vegetable oil and/or fatty material feed, is further in combination with an additional feed; said additional feed suitably being:
a fossil feed, i.e. a feed originating from a fossil fuel source, such as such as diesel, kerosene, naphtha, and vacuum gas oil (VGO), and/or
an intermediate hydrocarbon product such as a recycle oil, i.e. by recycling an intermediate hydrocarbon product produced in the process, such as a portion of a hydroprocessed hydrocarbon feed produced downstream, i.e. the hydroprocessed hydrocarbon feed or the further hydroprocessed hydrocarbon feed.

Hence, suitably said intermediated hydrocarbon product produced in the process is a portion of the hydroprocessed hydrocarbon feed or further hydroprocessed hydrocarbon feed.

In an embodiment, the process further comprises supplying said diesel and said maritime (marine) fuel as a heavy end, or a combination thereof, to a hydroisomerisation (HDI) step in a HDI reactor, and/or a hydrocracking (HCR) step in a HCR reactor, for providing said intermediate hydrocarbon product, such as said intermediate hydrocarbon product produced in the process.

Hence, in the separation section, for instance in a distillation column therefrom and from which diesel and marine fuel are withdrawn, any of these hydrocarbon products or a portion thereof is supplied to HDI and/or HCR. Thereby, such hydrocarbon product, for instance maritime fuel which is hydroprocesed in the HCR reactor, is advantageously added after the stabilized waste tyre pyrolysis oil feed has been combined with, suitably, the hydrotreated vegetable oil and/or a fatty material feed. A high synergy has been found by hydrotreating each of these streams separately as already described above.

In an embodiment, the process comprises a prior solvent-extraction step of the biocrude oil feed, such as a prior toluene-extraction step, for producing said waste pyrolysis oil feed.

In a second aspect, the invention envisages also a plant for conducting the process according to any of the above embodiments according to the first aspect of the invention. The plant comprises:
a conduit providing a bio-crude oil feed comprising 0.1-5 wt % oxygen (O), in which said bio-crude oil feed is a waste tyre pyrolysis oil feed;
a conduit providing a vegetable oil and/or fatty material feed;
a mixing point, such as mixing unit or junction, for combining the bio-crude oil comprising 0.1-5 wt % O with the vegetable oil and/or fatty material feed, for producing a hydrocarbon feed;
optionally, upstream said mixing point, a stabilization reactor arranged to receive the waste tyre pyrolysis oil feed and provide a stabilized waste tyre pyrolysis oil feed.

It would be understood that any of the embodiments according to the first aspect of the invention and associated benefits, may be used in connection with the second aspect of the invention.

### EXAMPLE: Increasing Cetane Index of Diesel While Improving Cold Flow Properties, as Well as Reducing Heavy End Fraction

A bio-crude oil is produced from the pyrolysis of waste tyres (hence, a waste tyre pyrolysis oil feed). The oxygen (O) content is in the range 0.5-2 wt % O. This feed is combined with hydrotreated vegetable oil (HVO) in different weight ratios, for instance 1:1 (50 wt % hydrotreated waste tyre pyrolysis oil (H-WTP oil) and 50 wt % HVO).

Despite the low O content, the waste tyre pyrolysis oil is rich in aromatics and the density of the diesel fraction is too high and the cetane index too low to fulfill EN590 diesel specs. HVO has very high cetane index and low density, but the cold flow properties are poor. The H-WTP and HVO are found to be miscible. Further, the blend of these two feeds interact synergistically to provide a diesel fuel in compliance with EN590 specs, by providing a high cetane index of produced diesel, low amount of heavy end fraction. Moreover, when combined within a particular range of weight ratios, a dramatic improvement in cold flow properties is achieved. The table below shows the results.

A stabilized and hydrotreated waste tyre pyrolysis oil (H-WTP oil) with a cetane index of 36 (CCI according to standard D4737) and a cloud point (CP) of 6° C. (according to standard D 5773) was mixed with a HVO (CCI 104 and CP 22° C.) using the following weight ratios: 75:25, 50:50, and 26:74. The results in the table show that mixing HVO with hydroprocessed (hydrotreated) waste tyre pyrolysis oil (H-WTP oil) increases the CCI for the waste tyre pyrolysis oil, i.e. co-feeding of hydrotreated tyre pyrolysis oil with vegetable oil results in a diesel with the desired CCI. Furthermore, it also showed that mixing HVO with a H-WTP oil surprisingly also decreases the CP of the H-WTP oil despite HVO having a much higher CP. Without being bound by any theory, this could be related to an increased solubility of the heavy end fraction of the H-WTP oil, which is more soluble in the lighter fractions when mixed with the C15-C18 alkanes present in the HVO, thus decreasing the CP. Therefore, mixing HVO with H-WTP oil not only improves the cetane index, but also the cloud point; in particular where the weight ratio of H-WTP oil to HVO is 60:40 wt % or 75:25 or 80:20 or 90:10 wt %.

| | | | | | |
|---|---|---|---|---|---|
| H-WTP oil, | 100 | 75 | 50 | 26 | 0 |
| conc (wt %) | | | | | |
| CCI (ASTM | 36 | 44 | 58 | 78 | 104 |
| D 4737) | | | | | |
| CP (ASTM | 6° C. | −4° C. | 8° C. | 15° C. | 22° C. |
| D 5773) | | | | | |

We claim:

1. Process for producing a hydrocarbon feed, comprising the steps of:
providing a bio-crude oil feed comprising 0.1-5 wt % oxygen (O);
providing a vegetable oil and/or fatty material feed;
combining the bio-crude oil feed comprising 0.1-5 wt % O with the vegetable oil and/or fatty material feed, for producing said hydrocarbon feed;
wherein said bio-crude oil feed comprising 0.1-5 wt % O is a waste tyre pyrolysis oil feed.

2. Process according to claim 1, the process further comprising:
prior to said combining step, supplying the waste tyre pyrolysis oil feed to a stabilization step in a stabilization reactor, for producing a stabilized waste tyre pyrolysis oil feed.

3. Process according to claim 2, wherein the stabilization step is conducted in continuous operation mode in a fixed bed reactor comprising supplying the bio-crude oil feed with hydrogen in the presence of any of a: Ni—Mo, Co—Mo, Ni—Cu, Mo, Pt, Pd, Ru, or Ni based catalyst, at a temperature of 20-240° C., a pressure of 50-150 barg, optionally a liquid hourly space velocity (LHSV) of 0.1-2 h⁻¹, and a hydrogen to liquid oil ratio, defined as the volume ratio of hydrogen to the flow of the liquid oil stream, of 250-3000 NL/L, 4., thereby forming said stabilized waste tyre pyrolysis oil feed.

4. Process according to claim 1, further comprising:
a pyrolysis step in a pyrolysis unit which comprises feeding to the pyrolysis unit: a solid feed stream comprising at least 50 wt % waste tyre-particles for producing said waste tyre pyrolysis oil feed.

5. Process according to claim 4, wherein the solid feed stream comprises at least 60 wt % waste tyre particles, and the waste tyre pyrolysis oil feed comprises 0.5-2 wt % O.

6. Process according to claim 1, wherein said vegetable oil and/or fatty material feed is a hydroprocessed vegetable oil and/or fatty material feed.

7. Process according to claim 1, further comprising supplying the vegetable oil and/or fatty material feed, prior to combining with the waste tyre pyrolysis oil feed, to a hydrodeoxygenation or deoxygenation (HDO/DO) step in a HDO/DO reactor, for producing a hydroprocessed vegetable oil and/or fatty material feed.

8. Process according to claim 1, further comprising supplying the waste tyre pyrolysis oil feed or the stabilized waste tyre pyrolysis oil feed, prior to combining with the vegetable oil and/or fatty material or with the hydroprocessed vegetable oil and/or fatty material feed, to a hydrodeoxygenation or deoxygenation (HDO/DO) step in a HDO/DO reactor, for producing a hydroprocessed waste tyre pyrolysis oil feed or a hydroprocessed stabilized waste tyre pyrolysis oil feed.

9. Process according to claim 1, wherein said HDO/DO step of the waste pyrolysis oil feed or the stabilized waste tyre pyrolysis oil feed, is conducted in the same HDO/DO reactor for conducting HDO/DO step of the vegetable oil and/or fatty material feed.

10. Process according to claim 1, further comprising supplying said hydrocarbon feed to a subsequent HDO/DO step for producing a hydroprocessed hydrocarbon feed.

11. Process according to claim 1, further comprising:
supplying said hydrocarbon feed or said hydroprocessed hydrocarbon feed to a subsequent hydroprocessing step in a downstream hydroprocessing section, and/or a hydrocracking (HCR) step in a HCR reactor, and/or a hydrodearomatization (HDA) in a HDA reactor for producing a further hydroprocessed hydrocarbon feed.

12. Process according to claim 11, comprising:
supplying the further hydroprocessed hydrocarbon feed to a separation step in a separation section for producing a hydrocarbon product, said hydrocarbon product being any one of: naphtha, diesel, jet fuel, maritime (marine) fuel as a heavy end, or combinations thereof.

13. Process according to claim 1, wherein the weight ratio (A:B) of waste tye pyrolysis oil feed (A) to vegetable oil and/or a fatty material feed (B) is in the range 50:50 wt % to of 90:10 wt %; such as 60:40, 70:30, 75:25, 80:20, or 85:15 wt %; and optionally, any of the HDO/DO steps is conducted in continuous mode under the conditions: 250-400° C., at a pressure of 50-150 bar, with a fixed bed catalyst in which the catalyst is NiMoS. and/or MOS

14. Process according to claim 1, wherein said vegetable oil and/or fatty material feed is any of: soy oil, rapeseed oil, corn oil, castor oil, cooked oil, animal fat, and combinations thereof.

15. Process according to claim 6, wherein the hydroprocessed vegetable oil and/or fatty material is selected from hydrotreated vegetable oil (HVO) or hydrotreated cooked oil.

16. Process according to claim 1, wherein the step of combining the waste tyre pyrolysis oil feed with the vegetable oil and/or fatty material feed, is further in combination with an additional feed; said additional feed being: a fossil feed such as such as diesel, kerosene, naphtha, and vacuum gas oil (VGO), and/or an intermediate hydrocarbon product such as a recycle oil.

17. Process according to claim 12, wherein the process further comprises supplying said diesel and said maritime (marine) fuel as a heavy end, or a combination thereof, to a hydroisomerisation (HDI) step in a HDI reactor, and/or a hydrocracking (HCR) step in a HCR reactor, for providing said intermediate hydrocarbon product.

18. Plant for conducting the process according to claim 1, comprising:
a conduit providing a bio-crude oil feed comprising 0.1-5 wt % oxygen (O), in which said bio-crude oil feed is a waste tyre pyrolysis oil feed;
a conduit providing a vegetable oil and/or fatty material feed; and
a mixing point for combining the bio-crude oil comprising 0.1-5 wt % O with the vegetable oil and/or fatty material feed, for producing a hydrocarbon feed;

19. The process of claim 10, wherein the HDO/DO step is carried out in a HDO/DO reactor.

20. The process of claim 11, wherein the hydroprocessing step carried out in the hydroprocessing section comprises a hydroisomerisation (HDI) step in a HDI reactor.

21. The process of claim 16, wherein the recycle oil is produced by recycling a portion of the hydroprocessed hydrocarbon feed or the further hydroprocessed hydrocarbon feed.

22. The plant of claim 18 comprising, upstream said mixing point, a stabilization reactor arranged to receive the waste tyre pyrolysis oil feed and provide a stabilized waste tyre pyrolysis oil feed.
